(19) United States
(12) Patent Application Publication
(10) Pub. No.: US 2016/0335198 A1
(43) Pub. Date: Nov. 17, 2016

(54) METHODS AND SYSTEM FOR MAINTAINING AN INDIRECTION SYSTEM FOR A MASS STORAGE DEVICE

(71) Applicant: Apple Inc., Cupertino, CA (US)

(72) Inventors: Andrew W. VOGAN, Gilroy, CA (US); Evgeny TELEVITCKIY, Mountain View, CA (US)

(21) Appl. No.: 14/710,495

(22) Filed: May 12, 2015

(51) Int. Cl. G06F 12/12

(52) U.S. Cl. CPC G06F 12/128; G06F 2212/69

(57) ABSTRACT

Disclosed herein are techniques for maintaining an indirection manager for a mass storage device. According to some embodiments, the indirection manager is configured to implement different algorithms that orchestrate a manner in which data is read from and written into memory sectors when handling I/O requests output by a computing device that is communicatively coupled to the mass storage device. Specifically, the algorithms utilize a mapping table that is limited to two levels of hierarchy: a first tier and a second tier, which constrains the overall size and complexity of the mapping table and can increase performance. The embodiments also set forth a memory manager that is configured to work in conjunction with the indirection manager to provide a mechanism for efficiently allocating and de-allocating variably-sized groups of sectors.

### FIELD

The described embodiments set forth an indirection system for implementing memory management within a mass storage device.

### BACKGROUND

Solid state drives (SSDs) are a type of mass storage device that share a similar footprint with (and provide similar functionality as) traditional magnetic-based hard disk drives (HDDs). Notably, standard SSDs—which utilize “flash” memory—can provide various advantages over standard HDDs, such as considerably faster Input/Output (I/O) performance. For example, average I/O latency speeds provided by SSDs typically outperform those of HDDs because the I/O latency speeds of SSDs are less-affected when data is fragmented across the memory sectors of SSDs. This occurs because HDDs include a read head component that must be relocated each time data is read/written, which produces a latency bottleneck as the average contiguity of written data is reduced over time. Moreover, when fragmentation occurs within HDDs, it becomes necessary to perform resource-expensive defragmentation operations to improve or restore performance. In contrast, SSDs, which are not bridled by read head components, can preserve I/O performance even as data fragmentation levels increase. SSDs also provide the benefit of increased impact tolerance (as there are no moving parts), and, in general, virtually limitless form factor potential. These advantages—combined with the increased availability of SSDs at consumer-affordable prices—make SSDs a preferable choice for mobile devices such as laptops, tablets, and smart phones.

Despite the foregoing benefits provided by SSDs, considerable drawbacks remain that have yet to be addressed. Specifically, conventional approaches for managing data stored by an SSD involve maintaining tree data structures (e.g., B+ trees) that include multi-layer hierarchies. Unfortunately, the B+ tree data structures can consume a significant amount of storage space within the SSD, and actively managing the B+ tree data structures can require a considerable amount of processing resources. Another drawback is that the overall I/O performance provided by the SSD typically scales inversely to the size and complexity of the B+ tree data structures, which correspondingly scale with the amount of data that is being managed by the SSD. For these reasons, it is desirable to establish a technique for organizing data stored by SSDs that reduces implementation complexity and memory requirements while improving overall performance.

### SUMMARY

The embodiments disclosed herein set forth a technique for managing data storage within a solid state drive (SSD). Specifically, and according to one embodiment, the technique involves implementing a hierarchical indirection system that is constrained to only two levels of hierarchy. The embodiments also set forth different indirection methods are utilized for maintaining the manner in which data is stored within the SSD. The different indirection methods can include, for example, (1) an indirection method for managing data that is disparately written into different sectors of the SSD—referred to herein as a “flat” indirection method, and (2) an indirection method for managing data that is disparately written into variably-sized groups of sectors within the SSD—referred to herein as a “simple” indirection method. These indirection methods, as well as various supplemental techniques for memory management, are described below in greater detail in conjunction with the accompanying FIGS.

One embodiment sets forth a method for implementing memory management for a storage device. The method includes the steps of managing a hierarchical structure that includes, at most, a first tier and a second tier, wherein: the first tier is associated with a plurality of first tier entries, and each first tier entry of the plurality of first tier entries defines: (i) an address of a sector of the storage device, or (ii) a pointer to a second tier entry associated with the second tier, and a format that identifies how data is stored in the second tier entry and any other second tier entries that follow the second tier entry.

Another embodiment sets forth a non-transitory computer readable storage medium configured to store instructions that, when executed by a processor included in a computing device, cause the computing device to implement memory management for a storage device, by carrying out steps that include: managing a hierarchical structure that includes, at most, a first tier and a second tier, wherein: the first tier is associated with a plurality of first tier entries, and each first tier entry of the plurality of first tier entries defines: (i) an address of a sector of the storage device, or (ii) a pointer to a second tier entry associated with the second tier, and a format that identifies how data is stored in the second tier entry and any other second tier entries that follow the second tier entry.

Yet another embodiment sets forth a computing device configured to implement memory management for a storage device. The computing device includes a storage device, and a processor configured to carry out steps that include: managing a hierarchical structure that includes, at most, a first tier and a second tier, wherein: the first tier is associated with a plurality of first tier entries, and each first tier entry of the plurality of first tier entries defines: (i) an address of a sector of the storage device, or (ii) a pointer to a second tier entry associated with the second tier, and a format that identifies how data is stored in the second tier entry and any other second tier entries that follow the second tier entry.

Other aspects and advantages of the embodiments described herein will become apparent from the following detailed description taken in conjunction with the accompanying drawings which illustrate, by way of example, the principles of the described embodiments.

### BRIEF DESCRIPTION OF THE DRAWINGS

The included drawings are for illustrative purposes and serve only to provide examples of possible structures and arrangements for the disclosed inventive apparatuses and methods for providing wireless computing devices. These drawings in no way limit any changes in form and detail that may be made to the embodiments by one skilled in the art without departing from the spirit and scope of the embodiments. The embodiments will be readily understood by the following detailed description in conjunction with the accompanying drawings, wherein like reference numerals designate like structural elements.

FIG. 1 illustrates a block diagram of different components of a system that is configured to implement the various techniques described herein, according to some embodiments.

FIG. 2A illustrates a conceptual diagram of four example types of encoding entries for first tier spans, according to one embodiment.

FIG. 2B illustrates a conceptual diagram of three example types of second tier entries that can be used to implement the flat indirection method and the simple indirection method, according to one embodiment.

FIG. 2C illustrates a conceptual diagram of three example types of second tier entries that can be used to implement a size extension in accordance with an extension component of a first tier span, according to one embodiment.

FIG. 3 illustrates a conceptual diagram of an example scenario that involves first tier spans, second tier entries, and the manner in which these entries can be used to reference data stored within sectors of a mass storage device.

FIG. 4 illustrates a method for utilizing a mapping table to implement the indirection techniques described herein, according to one embodiment.

FIG. 5 illustrates a conceptual diagram of an example scenario that involves applying the flat indirection method, according to one embodiment.

FIG. 6 illustrates a conceptual diagrams of an example scenario that involves applying a first write operation using the simple indirection method, according to one embodiment.

FIG. 7 builds on the conceptual diagram of FIG. 6, and involves applying a second write operation using the simple indirection method, according to one embodiment.

FIG. 8A illustrates a conceptual diagram that involves establishing doubly-linked lists and a search array in accordance with second tier entries to provide a mechanism for efficiently allocating and de-allocating variably-sized groups of sectors, according to one embodiment.

FIG. 8B illustrates a conceptual diagram of an example scenario that involves a search array for looking up doubly-linked lists, according to one embodiment.

FIG. 9 illustrates a detailed view of a computing device that can be used to implement the various components described herein, according to some embodiments.

### DETAILED DESCRIPTION

Representative applications of apparatuses and methods according to the presently described embodiments are provided in this section. These examples are being provided solely to add context and aid in the understanding of the described embodiments. It will thus be apparent to one skilled in the art that the presently described embodiments can be practiced without some or all of these specific details. In other instances, well known process steps have not been described in detail in order to avoid unnecessarily obscuring the presently described embodiments. Other applications are possible, such that the following examples should not be taken as limiting.

The embodiments described herein set forth an indirection system that includes a two-tier indirection structure—also referred to herein as a mapping table—to locate data stored on a mass storage device (e.g., an SSD). Specifically, the mapping table is constrained to two depth levels, where supplemental depth levels are not required. Constraining the mapping table to two levels of hierarchy can provide several benefits over conventional multi-level hierarchy approaches whose depths are not constrained. For example, constraining the mapping table to two levels of hierarchy helps reduce the amount of memory consumed by the mapping table, thereby increasing the amount of memory that is available to the computing device to carry out other tasks. Moreover, constraining the mapping table to two levels of hierarchy correspondingly limits the overall complexity of the mapping table, which can improve read/write performance as only a maximum of two levels of hierarchy are referenced within the mapping table when handling I/O requests.

One embodiment sets forth an indirection manager that is configured to implement and manage the two-tier indirection structure. The indirection manager is also configured to implement various indirection methods that are conducive to (1) minimizing the amount of memory required to store the two-tier indirection structure, and (2) minimizing the overall latency involved in carrying out I/O operations. The different indirection methods can include an indirection method for managing data that is disparately written into different sectors of the SSD, which is referred to herein as a “flat” indirection method. The different indirection methods can also include an indirection method for managing data that is disparately written into variably-sized groups of sectors within the SSD, which is referred to herein as a “simple” indirection method. These indirection methods, as well as various supplemental techniques for memory management, are described below in greater detail in conjunction with the accompanying FIGS.

Another embodiment sets forth a memory manager that is configured to work in conjunction with the indirection manager to provide a mechanism for efficiently allocating and de-allocating variably-sized groups of sectors. According to one embodiment, and as described in greater detail herein, the memory manager is configured to organize groups of free sectors using doubly-linked lists. Specifically, the memory manager is configured to inspect second tier entries to identify contiguous spans of free sectors, and establish doubly-linked lists that organize the contiguous spans of free sectors in a manner that makes them readily identifiable. According to one embodiment, the memory manager can be configured to organize the doubly-linked lists into “buckets” so that specifically-sized groups of free sectors can be identified through a single lookup. For example, the memory manager can be configured to maintain an array having a set of entries, where each entry of the array points to doubly-linked lists that define groups of free sectors whose sizes correspond to the index of the entry. Additionally, the memory manager can be configured to implement an allocation node that can be used to organize a large group of free sectors from which variably-sized groups of sectors can be allocated. Specifically, the allocation node can be used when the memory manager is seeking a group free sectors of a particular size (e.g., using the bucket approach described above) and the particular size is not available.

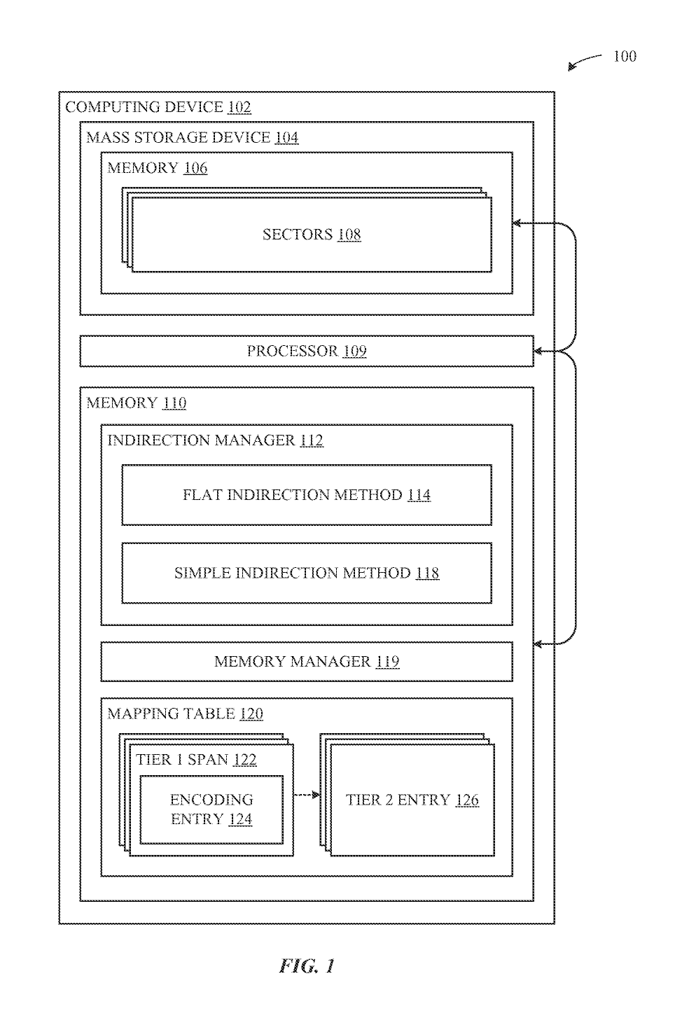

FIG. 1 illustrates a block diagram 100 of a computing device 102—e.g., a smart phone, a tablet, a laptop, etc.—that is configured implement the various techniques described herein. As shown in FIG. 1, the computing device 102 can include a mass storage device 104 (e.g., an SSD) that is communicatively coupled to the computing device 102 and used by the computing device 102 for storing data (e.g., operating system (OS) files, user data, etc.). In accordance with the illustration of FIG. 1, the mass storage device 104 includes a memory 106 (e.g., a flash memory) that is sequentially partitioned into memory sectors 108, where each memory sector 108 represents a fixed-size unit of the memory 106 (e.g., four (4) kilobytes (KB) of data). It is noted that the 4 KB sectors 108 described herein are merely exemplary, and that alternative approaches for sequentially partitioning the memory 106 are also compatible with the techniques described herein.

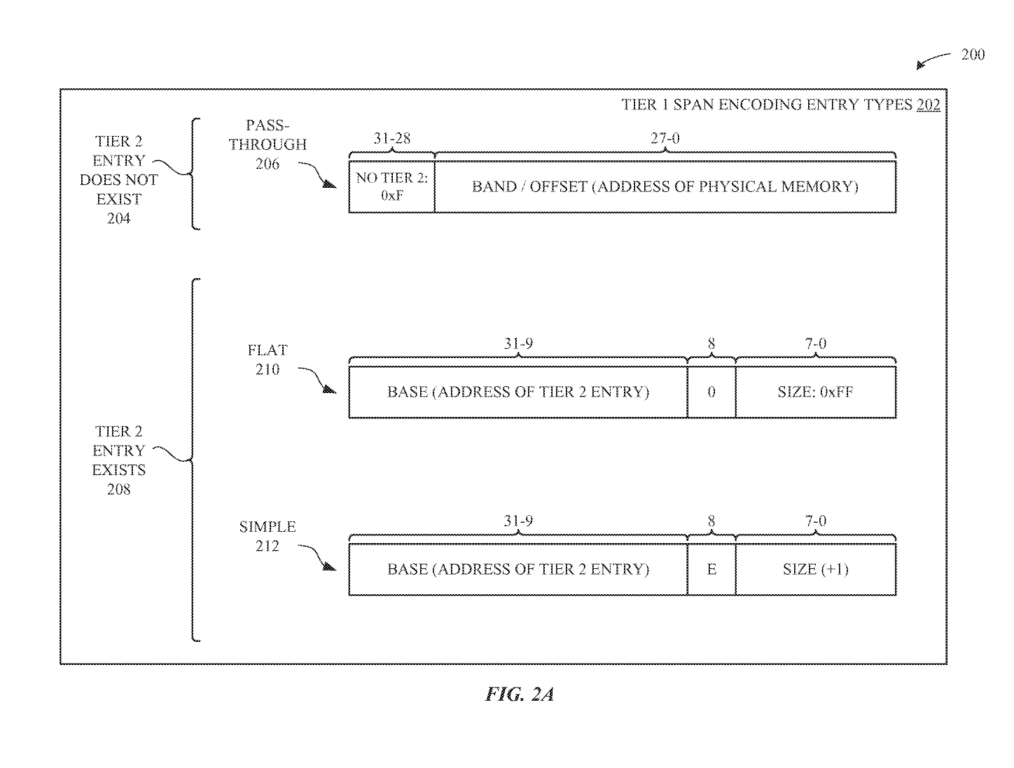

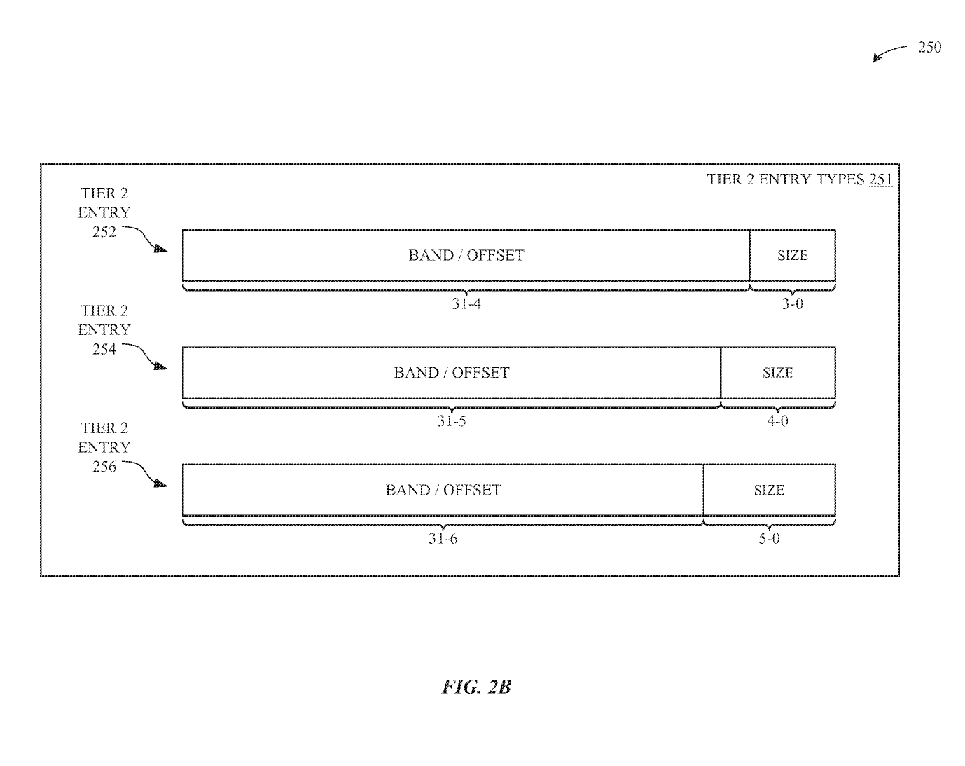

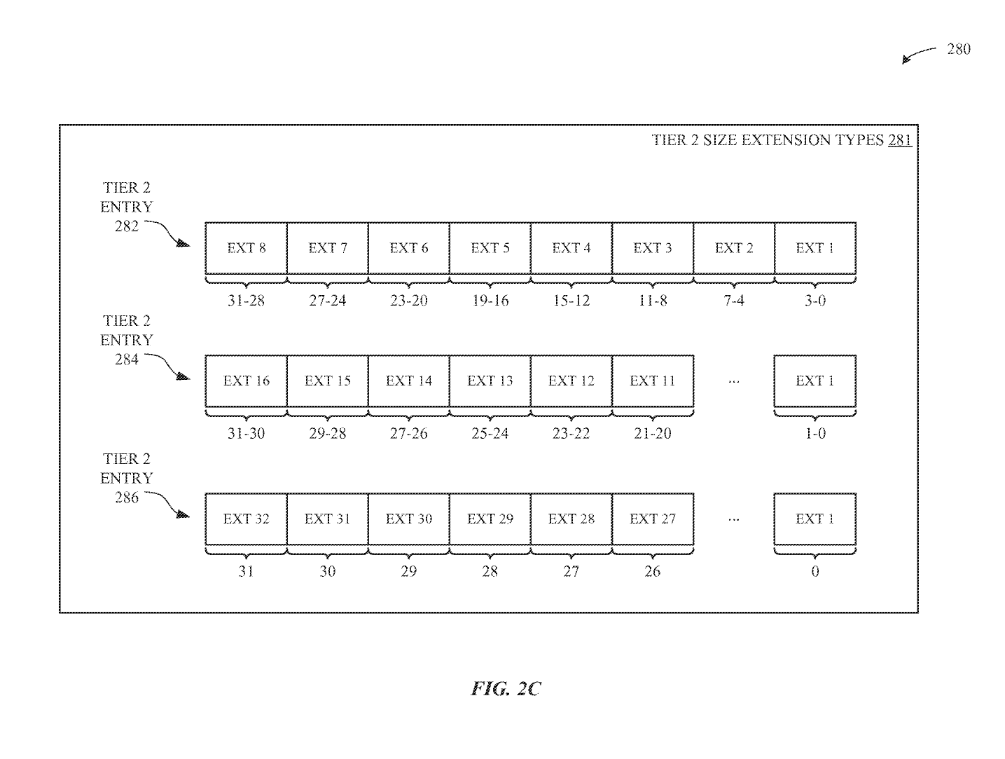

As shown in FIG. 1, the computing device 102 includes a processor 109 that, in conjunction with a memory 110 (e.g., a dynamic random access memory (DRAM)), is configured to implement an indirection manager 112, a memory manager 119, and a mapping table 120. According to one embodiment, the mapping table 120 is configured to include first tier spans 122, where each first tier span 122 is configured to include an encoding entry 124. It is noted that the indirection manager 112 can be configured to operate in accordance with how the sectors 108 are partitioned within the memory 106. For example, when each sector 108 represents a 4 KB sector of memory, the indirection manager 112 can consider each first tier span 122 to represent two hundred fifty-six (256) sectors 108. As described in greater detail herein, the values included in the encoding entry 124 of a first tier span 122 indicate whether (1) the first tier span 122 directly refers to a physical location (e.g., an address of a sector 108) within the memory 106, or (2) the first tier span 122 directly refers (e.g., via a pointer) to a second tier entry 126. According to one embodiment, when condition (1) is met, it is implied that all sectors 108 associated with the first tier span 122 are contiguously written, which can provide a compression ratio of 1/256 (when each first tier span 122 represents two hundred fifty-six (256) sectors). More specifically, this compression ratio can be achieved because the first tier span 122 merely stores a pointer to a first sector 108 of the two hundred fifty-six (256) sectors 108 associated with the first tier span 122, and no second tier entries 126 are required. Alternatively, when condition (2) is met, information included in the first tier span 122—and, in some cases, information included in the second tier entry 126 pointed to by the first tier span 122—indicates (i) a number of second tier entries 126 that follow the second tier entry 126, as well as (ii) how the information in the second tier entry 126 should be interpreted. As described in greater detail below, the indirection manager 112 can implement indirection methods to achieve meaningful compression ratios even when second tier entries 126 are associated with a first tier span 122. A more detailed description of the first tier spans 122, the encoding entries 124, and the second tier entries 12.6 is provided below in conjunction with FIGS. 2A-2C.

The indirection manager 112 orchestrates the manner in which the memory sectors 108 are referenced when handling I/O requests generated by the computing device 102. More specifically, the indirection manager 112 is configured to implement different indirection methods in accordance with the mapping table 120. According to one embodiment, and as illustrated in FIG. 1, the indirection manager 112 can be configured to implement a “flat” indirection method 114 and a “simple” indirection method 118. When the indirection manager 112 is tasked with carrying out an I/O request, the indirection manager 112 identifies an appropriate one of the foregoing indirection methods based on the nature of the I/O request (e.g., a size of a new file to be written), as well as a state of the mapping table 120. Upon selecting an indirection method that is appropriate, the indirection manager 112 carries out the I/O request in accordance with the selected indirection method.

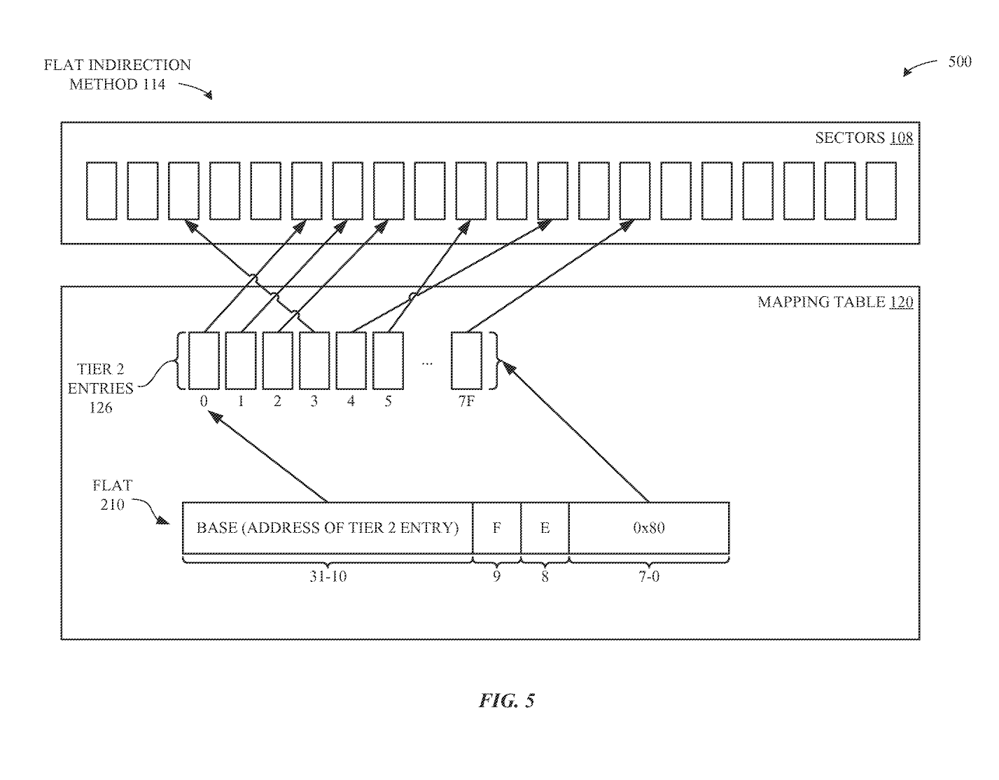

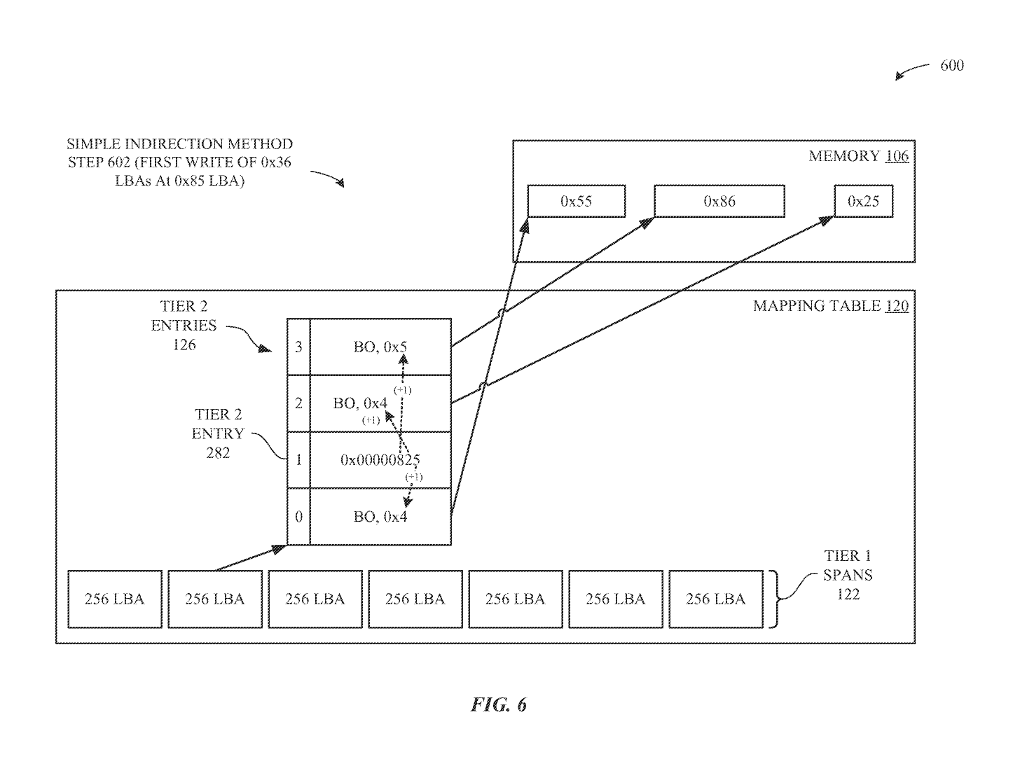

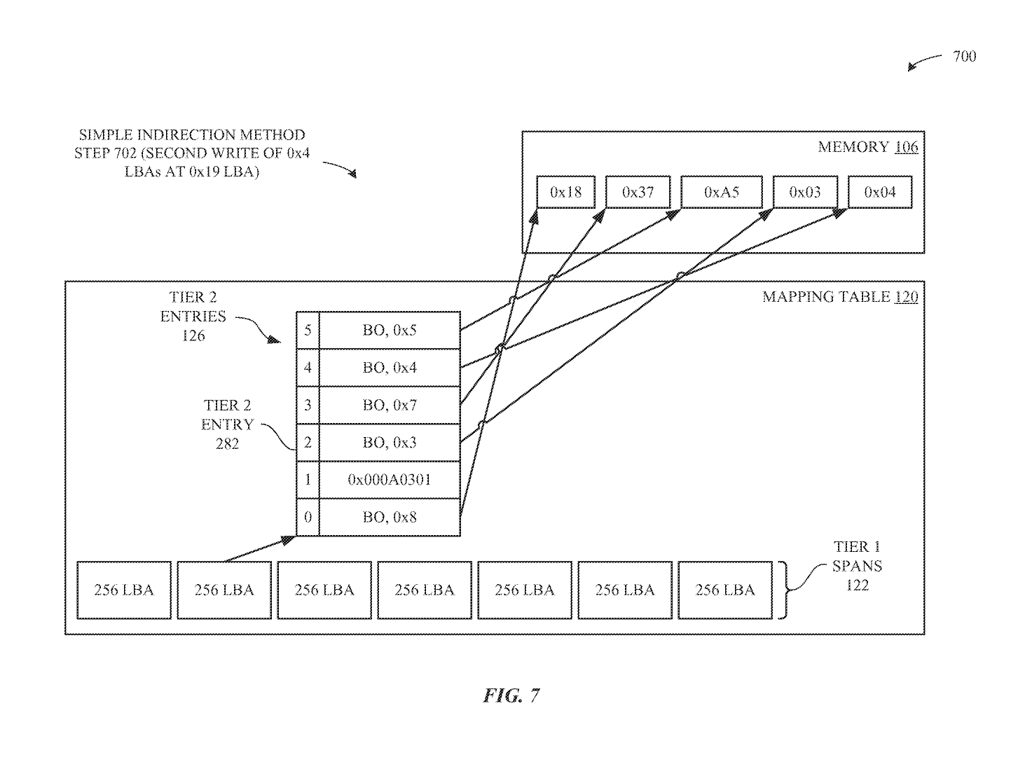

According to one embodiment, the flat indirection method 114 is used for managing data that is disparately written into different sectors 108 of the memory 106. Specific details surrounding the implementation of the flat indirection method 114 are described below in greater detail in conjunction with FIG. 5. Finally, the simple indirection method 118 is used for managing data that is disparately written into variably-sized groups of sectors 108 within the memory 106. Specific details surrounding the implementation of the simple indirection method 118 are described below in greater detail in conjunction with FIGS. 6-7.

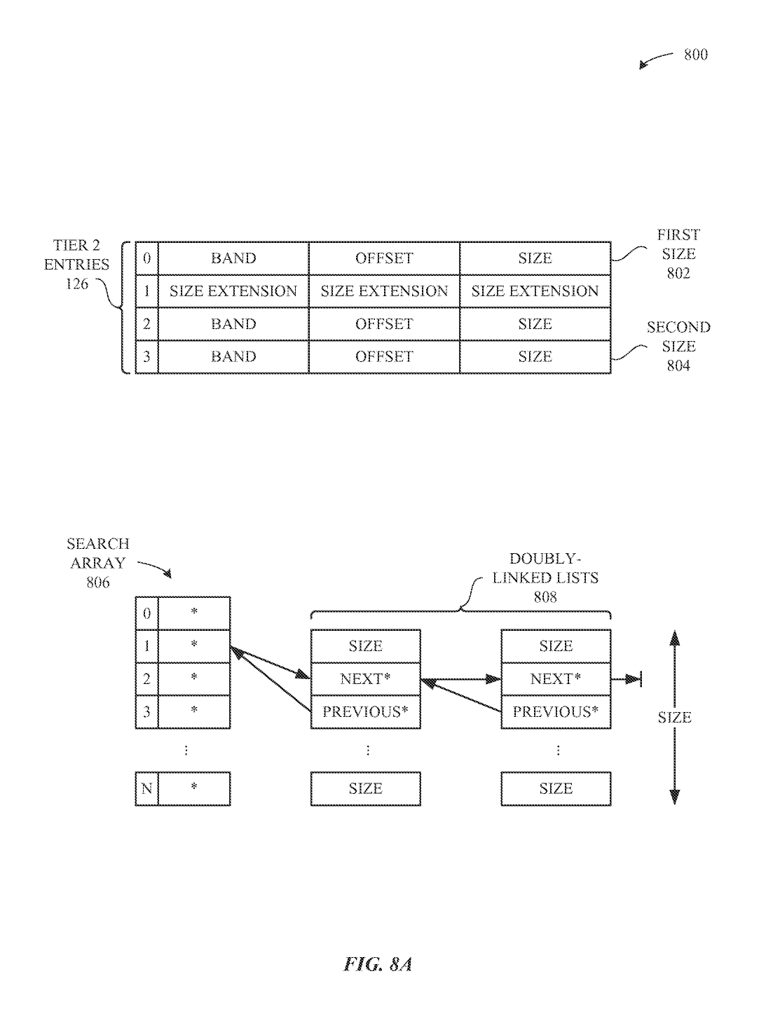

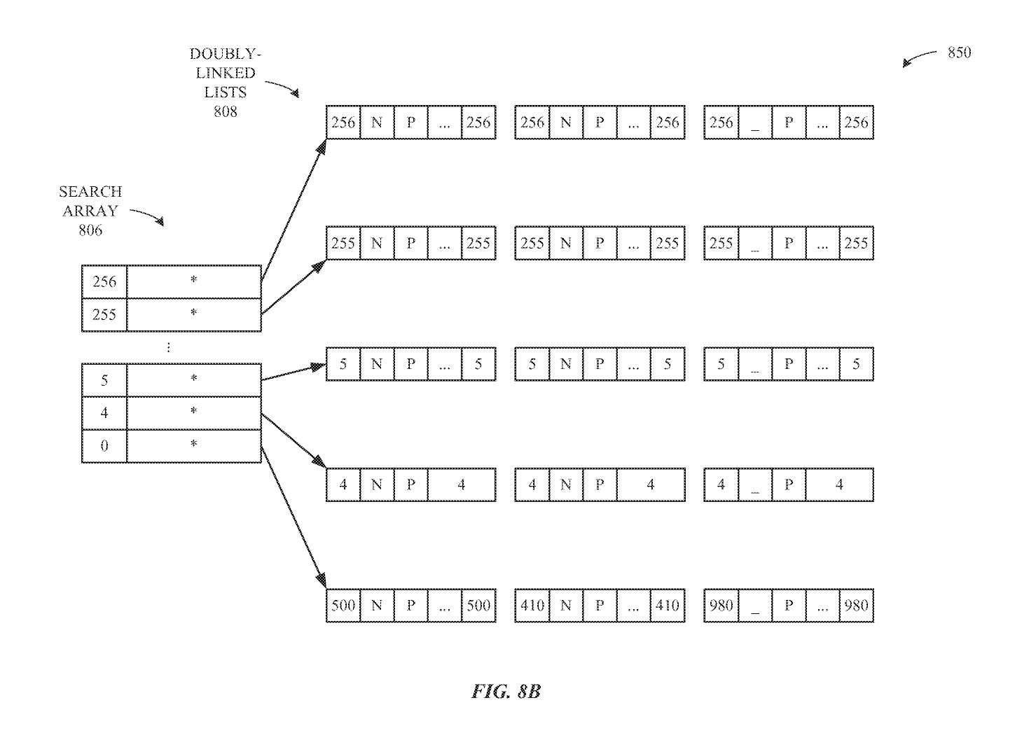

The memory manager 119 is configured to work in conjunction with the indirection manager 112 to provide a mechanism for efficiently allocating and de-allocating variably-sized. groups of sectors 108. According to one embodiment, and as described in greater detail below in conjunction with FIGS. 8A-8B, the memory manager is configured to organize groups of free sectors 108 using doubly-linked lists. Specifically, the memory manager 119 is configured to inspect the starting second tier entry 126 and the ending second tier entry 126 among second tier entries 126 that correspond to first tier spans 122. Using this approach, the memory manager 119 can be configured to establish doubly-linked lists that, in turn, can be used to identify group sizes of free sectors 108.

According to one embodiment, the memory manager 119 can be configured to organize the doubly-linked lists into “buckets” so that specifically-sized groups of free sectors 108 can be readily identified. To implement these buckets, the memory manager 119 can be configured to, for example, maintain an array having two hundred fifty-seven (257) entries, where each entry of the array points to doubly-linked lists that define groups of free sectors 108 whose sizes correspond to the index of the entry. For example, entry five (5) of the array would point to doubly-linked lists that define groups of five (5) free sectors 108, entry ten (10) of the array would point to doubly-linked lists that define groups of ten (10) free sectors 108, and so on. According to one approach, entry zero (0) of the array can be reserved to point to doubly-linked lists that define groups of free sectors 108 whose sizes exceed the upper bound limit (e.g., two hundred fifty-six (256)) of the array. According to one embodiment, the memory manager 119 can be configured to disregard smaller groups of sectors 108 (e.g., four sectors 108 or fewer) and not include such groups in the doubly-linked lists. Instead, these smaller groups of sectors 108 can be utilized as changes to the organization of the memory 106 occur, e.g., through reclamation during cleaning up procedures (e.g., defragmentation operations), de-allocation of adjacent sectors 108, and the like.

Additionally, the memory manager 119 can be configured to implement an allocation node that can be used to organize a large group of free sectors 108 from which variably-sized groups of sectors 108 can be allocated. Specifically, the allocation node can be used when the memory manager 119 is seeking a group free sectors 108 of a particular size (e.g., using the bucket approach described above) and the particular size is not available. When this occurs, the memory manager 119 can de-allocate a group of free sectors 108 from the allocation node in accordance with the desired size. This is beneficial in comparison to, for example, defaulting to seeking out a next-available group of free sectors 108 within the array, which would increase fragmentation and decrease overall efficiency. A more detailed explanation of the foregoing techniques is provided below in conjunction with FIGS. 8A-8B.

FIG. 2A illustrates a conceptual diagram 200 of four example types 202 of encoding entries 124 (of first tier spans 122), according to one embodiment. As shown in FIG. 2A, each example type 202 falls into one of two categories. Specifically, a first category 204 includes first tier spans 122 that do not reference second tier entries 126, and a second category 208 includes first tier spans 122 that reference second tier entries 126. According to one embodiment, each first tier span 122 can be 32-bits in length, and values of each bit of the 32-bits can be set to indicate, among the four example types 202, an example type 202 to which the first tier span 122 corresponds. It is noted that the techniques set forth herein are not limited to 32-bits/the formatting practices illustrated in FIGS. 2A-2C, and that these techniques can be implemented using different bit-lengths and formatting practices. A detailed description of each of the four example types 202 is provided below in conjunction with FIG. 2A.

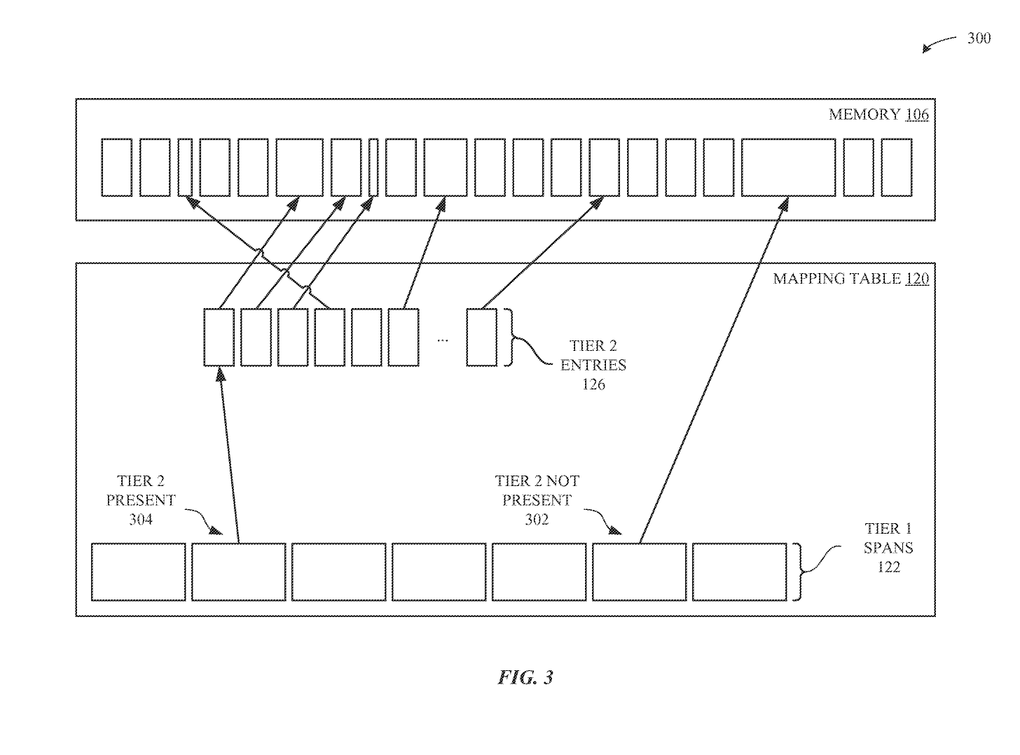

As shown in FIG. 2A, the first category 204 includes an example type 202 referred herein as a pass-through entry 206. A pass-through entry 206 represents a first tier span 122 that does not refer to a second tier entry 126, but instead refers directly to a physical address (e.g., of a particular sector 108) within in the memory 106. According to one embodiment, and as illustrated in FIG. 2A, the bits 31-28 of a first tier span 122 can be assigned the hexadecimal value 0×F (i.e., 1111) to function as a flag that indicates the first tier span 122 is a pass-through entry 206. Specifically, when the bits 31-28 of the first tier span 122 are assigned the hexadecimal value 0×F, the bits 27-0 can be used to store a physical address within the memory 106. According to one embodiment, the bits 27-0 can be logically separated in a manner that establishes at least two different components of the physical address within the memory 106. For example, the physical address can be separated into a “band” component and an “offset” component that correspond to the manner in which the memory 106 is partitioned. To implement this logical separation, a global variable can be used to identify, for example, a fixed size of the offset component. For example, when the global variable indicates that the offset component has a fixed size of 8 bits, then the bits 27-8 can be used to identify the band component, and the bits 7-0 can be used to identify the offset component. In turn, the band component, in conjunction with the offset component, can be used to access the physical address (e.g., of a sector 108) within the memory 106. It is noted that the physical address stored in a pass-through entry 206 represents a starting point (e.g., a starting sector 108) within the memory 106, and that data is contiguously written into a number of sectors (e.g., two hundred fifty-five (255) sectors 108) that follow the starting sector 108. According to one embodiment, this number of sectors corresponds to a granularity by which the first tier spans 122 are separated from one another, e.g., two hundred and fifty-six (256) sectors can correspond to each first tier span 122 when the first tier span 122 represents a pass-through entry 206. An example illustration of a pass-through entry 206 is provided in FIG. 3.

As previously set forth above, the second category 208 includes first tier spans 122 that are configured to reference second tier entries 126. Specifically, and as shown in FIG. 2A, the second category 208 includes a flat entry 210 and a simple entry 212. As shown in FIG. 2A, bits 31-9 of each of the fiat entry 210 and the simple entry 212 represent a “base address” component used to store a pointer to a specific second tier entry 126. As also shown in FIG. 2A, each of the flat entry 210 and the simple entry 212 include a 1-bit “extension” component (illustrated in FIG. 2A as “E”). It is noted that the extension component are simply ignored when processing flat entries 210, but that they can apply, for the reasons set forth below, to the simple entries 212. As further shown in FIG. 2A, each of the flat entry 210 and the simple entry 212 include a “size” component that is used to identify a number of second tier entries 126 that correspond to the first tier span 122. Notably, and according to one embodiment, it is inherent that a value of one (1) is added to the size component, which is reflected by the (+1) notation illustrated throughout FIG. 2A. It is also noted that the manner in which the foregoing bits are logically separated is customizable, e.g., the number of bits that make up the base address component can be increased (thereby decreasing the number of bits that make up the size component) to account for different storage capacities of the memory 106.

According to one embodiment, and as illustrated in FIG. 2A, a first tier span 122 corresponds to a flat entry 210 when the bits 31-28 are not assigned the hexadecimal value 0×F (as with a pass-through entry 206), but the bits 7-0—which represent the size component of the first tier span 122—are assigned the hexadecimal value 0×FF. Alternatively, a first tier span 122 corresponds to a simple entry 212 when the bits 31-28 are not assigned the hexadecimal value 0×F (as with a pass-through entry 206), and the bits 7-0 are not assigned the hexadecimal value 0×FF (as with a flat entry 210). Finally, as described in greater detail herein, the extension component of a simple entry 212 at hit 8 indicates whether the second tier entries 126 are formatted in accordance with a particular size extension, which is described below in greater detail in conjunction with FIG. 2C.

Additionally, FIG. 2B illustrates a conceptual diagram 250 of three example types 251 of second tier entries 126 that can be used to implement the flat indirection method 114 and the simple indirection method 118, according to one embodiment. Specifically, the components of each example type 251 can be partitioned in accordance with a capacity of the memory 106. For example, when the memory 106 has a capacity of two hundred fifty-six (256) gigabytes (GB), the format of the second tier entry 252 of FIG. 2B can be utilized, where bits 31-4 define a band/offset component for referencing a particular area of the memory 106, and bits 3-0 define a size component. In another example, when the memory 106 has a capacity of one hundred twenty-eight (128) GB, the format of the second tier entry 254 of FIG. 2B can be utilized, where bits 31-5 define a band/offset component for referencing a particular area of the memory 106, and bits 4-0 define a size component. In yet another example, when the memory 106 has a capacity of sixty-four (64) GB, the format of second tier entry 256 can be utilized, where bits 31-6 define a band/offset component for referencing a particular area of the memory 106, and bits 5-0 define a size component. It is noted that the techniques described herein are not limited to the example types 251 shown in FIG. 2B but that the second tier entries 126 can be formatted to have different lengths, partitions, and components.

Additionally, FIG. 2C illustrates a conceptual diagram 280 of three example types 281 of second tier entries 12.6 that can be used to implement a size extension in accordance with the extension component of a first tier span 122, according to one embodiment. As shown in FIG. 2, components of each example type 281 can be partitioned in accordance with the number of second tier entries 126 that are associated with the first tier span 122. For example, when eight (8) or fewer second tier entries 126 are associated with the first tier span 122, the format of the second tier entry 282 can be used such that the size component of each of the eight (8) or fewer second tier entries 126 is extended by four bits. In another example, when sixteen (16) or fewer second tier entries 126 are associated with the first tier span 122, the format of the second tier entry 284 can be used such that the size component of each of the sixteen (16) or fewer second tier entries 126 is extended by two bits. In yet another example, when thirty-two (32) or fewer second tier entries 126 are associated with the first tier span 122, the format of the second tier entry 286 can be used such that the size component of each of the thirty-two (32) or fewer second tier entries 126 can is extended by one bit. Detailed examples that set forth the manner in which the size extensions are implemented are provided below in conjunction with FIGS. 6-7.

FIG. 3 illustrates a conceptual diagram 300 of an example scenario that involves first tier spans 122, second tier entries 126, and the manner in which these entries can be used to reference data stored within sectors 108 of the memory 106. According to the example illustrated in FIG. 3, several first tier spans 122 are established, where at least one of the first tier spans 122—represented by element 302 in FIG. 3—does not have a corresponding second tier entry 126, and instead provides a direct reference to a sector 108 of the memory 106. According to this example, the element 302 can represent a pass-through entry 206 of FIG. 2A, where bits 31-28 are assigned the hexadecimal value 0×F (to indicate there is no corresponding second tier entry), and the remaining bits 27-0 establish the band/offset components that can be used to directly reference a sector 108 of the memory 106. As also illustrated in FIG. 3, at least one of the first tier spans 122—represented by element 304 in FIG. 3—has a corresponding second tier entry 126 that establishes an indirect reference between the element 302 and a sector 108 of the memory 106.

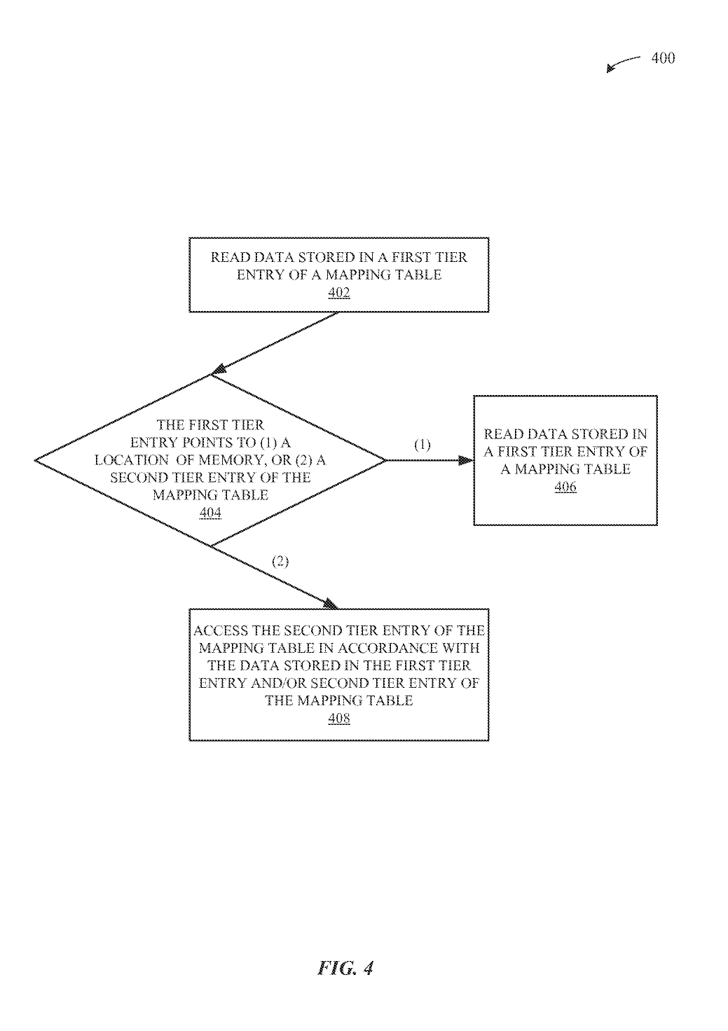

FIG. 4 illustrates a method 400 for utilizing the mapping table 120 to implement the indirection techniques described herein, according to one embodiment. As shown in FIG. 4, at step 402, the indirection manager 112, in response to an I/O request, reads data stored in a first tier span 122 that corresponds to the I/O request (e.g., at a logical block address (LBA) within the first tier span 122). Specifically, at step 402, the indirection manager 112 references the encoding entry 124 of the first tier span 122 to identify whether the first tier span 12.2 is associated with a second tier entry 126. At step 404, the indirection manager 112 determines, based on the encoding entry 124 of the first tier span 122, whether (1) the first tier span 122 identifies a location within the memory 106 (i.e., the first tier span 122 is a pass-through entry 206), or (2) the first tier span 122 identifies a second tier entry 126. If, at step 402, condition (1) is met, then the method proceeds to step 406, where the indirection manager 112 accesses the memory 106 in accordance with the identified location. Otherwise, when condition (2) is met, the method 400 proceeds to step 408, where the indirection manager 112 accesses the second tier entry 126 associated with the first tier span 122.

Accordingly, FIGS. 2-4 establish a high-level overview of the manner in which first tier spans 122 can be used to either directly reference sectors 108 within the memory 106 (as with pass-through entries 206), or indirectly reference sectors 108 through second tier entries 126 (as with flat entries 210 and simple entries 212). It is noted that the flat entries 210 and simple entries 212 individually—and differently—affect the manner in which the corresponding second tier entries 126 are formatted and managed. Accordingly, a detailed explanation of the fiat indirection method 114 is provided below in conjunction with FIG. 5, and a detailed explanation of the simple indirection method 118 is provided below in conjunction with FIGS. 6-7.

FIG. 5 illustrates a conceptual diagram 500 of an example scenario that applies to the flat indirection method 114, according to one embodiment. As shown in FIG. 5, the example scenario involves a first tier span 122 (specifically, a flat entry 210), second tier entries 126, and sectors 108 within the memory 106. As previously described above in conjunction with FIG. 2A, the base address component (bits 31-10) of the fiat entry 210 points to a specific one (i.e., first) of the second tier entries 126, and the size component (bits 7-0) of the flat entry 210 indicates a total number of the second tier entries 126 that correspond to the flat entry 210. In accordance with the example illustrated in FIG. 5, the size component, which represents the hexadecimal value 0×7F (with an implied +1=hexadecimal value 0×80)—establishes that one hundred twenty-eight (128) second tier entries 126 correspond to the flat entry 210. Moreover, and as described above in conjunction with FIG. 2A, the band/offset component of each second tier entry 126 stores a pointer to a particular one of the sectors 108. Notably, each second tier entry 126 can be formatted in accordance with one of the example types 251 of second tier entries 126 described above in conjunction with FIG. 2B. For example, if the capacity of the memory 106 is two hundred fifty-six (256) GB, then each second tier entry 126 can be formatted in accordance with the format of the second tier entry 252 of FIG. 2B. Thus, the flat indirection method 114 enables an efficient lookup of data that is disparately-written into sectors 108 of the memory 106, and requires only two different levels of hierarchy to be parsed by the indirection manager 112.

FIGS. 6-7 illustrate conceptual diagrams 600 and 700 of an example scenario where the indirection manager 112 applies the simple indirection method 118, according to one embodiment. As shown in FIG. 6, a step 602 involves a multi-sector 108 granularity write operation—specifically, fifty-four (54) (hexadecimal value 0×36) sectors 108—occurring at an LBA having the hexadecimal value 0×85 within the first tier span 122 (i.e., the one hundred thirty-third (133) sector 108 of the first tier span 122). In response to the first write operation, and as shown in FIG. 6, the indirection manager 112 establishes a second tier entry 126 (at index 0) and updates the first tier span 122 to point to the second tier entry 126. This would involve, for example, updating the format of the first tier span 122 to the format of a simple entry 212. This would also involve updating the values of the fields of the first tier span 122—specifically, the base address component (bits 31-10) to point to the second tier entry 126 (having index 0), and the size component (bits 7-0) to reflect the number of second tier entries 126 that are ultimately required to properly reflect the execution of step 602—which, as described in greater detail below, involves a total of four separate second tier entries 126.

As shown in FIG. 6, the second tier entry 126 (at index 0) is formatted in accordance with one of the second tier entry types 251 of FIG. 2B—e.g., the second tier entry 252, where bits 31-4 establish a band/offset component, and bits 3-0 describe a size component. As shown in FIG. 6, the second tier entry 126 (at index 0) is configured to point to a starting sector 108. Notably, because the group of sectors 108 has a size of hexadecimal value 0×55—which exceeds the 4-bit size field of the second tier entry 126 (having index 0)—the indirection manager 112 utilizes the extension techniques set forth herein, which first involves updating the extension component (bit 8) of the first tier span 122 to have a value of “1”. Again, this indicates that one of the second tier entries 126 serves to extend the size component of each of the second tier entries 126. In turn, the indirection manager 112 establishes a second tier entry 126 (having index 1) in accordance with the example types 281 described above in conjunction with FIG. 2C. In particular, as eight (8) or fewer second tier entries 126 are associated with the first tier span 122, the format of the second tier entry 282 of FIG. 2C is utilized, where bits 3-0 of the second tier entry 282 serve to extend the size component of the second tier entry 126 (having index 0) that points to the group of sectors 108 sized in accordance with the hexadecimal value 0×55. As shown in FIG. 6, bits 3-0 of the 32-bit second tier entry 126 (having index 1) point to the size component of the second tier entry 126 (having index 0), such that the two values make up the hexadecimal value 0×54. Notably, and as previously described herein, the size component has an implied +1, so the hexadecimal value of 0×54, when processed by the indirection manager 112, correctly interprets the hexadecimal value of 0×54 as the hexadecimal value 0×55, which coincides with the size of the group of sectors 108 to which the second tier entry 126 (having index 0) corresponds. As further shown in FIG. 6, additional second tier entries 126 are generated in accordance with other fragments that exist within the first tier span 122 as a consequence of step 602.

The conceptual diagram 700 of FIG. 7 continues the example scenario set forth in FIG. 6 and described above, and involves a step 702 where a multi-sector 108 granularity write operation—specifically, four sectors 108—occurs at an LBA having the hexadecimal value 0×19 within the first tier span 122 (i.e., the twenty-fifth (25) sector 108 of the first tier span 122). Here, two additional second tier entries 126 are generated in response to step 702: one second tier entry 126 (having index 4), and another second tier entry 126 (having index 5). As further shown in FIG. 7, each of the second tier entries 126 are updated in accordance with the second tier entry 12.6 (having index 1) that is used to implement the size extension.

Accordingly, FIGS. 6-7 illustrate conceptual diagrams 600 and 700 of an example scenario where the indirection manager 112 applies the simple indirection method 118. It is noted that the indirection manager 112 is configured to update the second tier entry 126 (having index 1) in accordance with the number of second tier entries 126 that correspond to the first tier span 122 as subsequent write operations associated with the first tier span 122 are processed by the indirection manager 112. For example, when more than eight (8) but fewer than sixteen (16) second tier entries 126 are established, the indirection manager 112 is configured to update the second tier entry 12.6 in accordance with the format of the second tier entry 284 of FIG. 2C, where bits 1-0 of the second tier entry 284 serve to extend the size component of the second tier entry 126 (having index 0), bits 3-2 of the second tier entry 284 serve to extend the size component of the second tier entry 126 (having index 2), and so on. It is father noted that the indirection manager 112 will continue to implement the simple indirection method 118 when subsequent write operations continue to be variable in size.

In some cases, when the largest fragment within the first tier span 122 does not require the size extension techniques to be utilized, the indirection manager 112 can be configured to set the value of the extension component (bit 8) of the first tier span 122 to “0”, and update the second tier entries 126 accordingly. This can involve, for example, removing the second tier entry 126 that stores the size extension information (e.g., the second tier entry 126 having index 1 in FIGS. 6-7), and updating the size components of the remaining second tier entries 126 to reflect the removal. Moreover, in some cases, the indirection manager 112 can be configured to trigger a cleanup operation that involves executing a series of operations that enable the indirection manager 112 to eliminate the second tier entries 126 and convert the format of the first tier span 122 to correspond to a pass-through entry 206. This can involve, for example, reading data that corresponds to the first tier span 122 and contiguously writing the data back into memory, updating the first tier span 12.2 in accordance with the format of a pass-through entry 206, and eliminating the second tier entries 126 that are associated with the first tier span 122, thereby conserving memory and increasing efficiency.

FIG. 8A illustrates a conceptual diagram 800 that involves establishing doubly-linked lists 808 and a search array 806 in accordance with second tier entries 126 to provide a mechanism for efficiently allocating and de-allocating variably-sized groups of sectors 108, according to one embodiment. As shown in FIG. 8A, four example second tier entries 126 are shown, where a starting second tier entry 126 (having index 0) is associated with a first size 802, and an ending second tier entry 126 (having index 3) is associated with a second size 804. According to one embodiment, the memory manager 119 is configured to inspect the first size 802 and the second size 804 to establish a doubly-linked list that, in turn, can be used to identify a group of free sectors 108 whose size corresponds to the sizes indicated by the first size 802 and the second size 804. As the memory manager 119 establishes doubly-linked lists for other second tier entries 126, the memory manager 119 can chain together liked-sized doubly-linked lists and organize them in accordance with the search array 806, which is described below in greater detail.

As shown in FIG. 8A, the search array 806 can be used to organize the doubly-linked lists into “buckets” so that specifically-sized groups of free sectors 108 can be readily identified. To implement these buckets, each entry of the search array 806 points to doubly-linked lists that define groups of free sectors 108 whose sizes correspond to the index of the entry. According to one example, when the memory manager 119 establishes a first doubly-linked list that represents a group of free sectors 108 having a size of seven (7), and subsequently establishes a second doubly-linked list that represents another group of free sectors 108 having a size of seven (7), the memory manager 119 can chain the first and second doubly-liked lists together using the next/previous pointers that are associated with the first and second doubly-linked lists. In turn, the memory manager 119 can update the entry of the search array 806 at index seven (7) to point to the first doubly-linked list (and vice-versa), and update the first doubly-linked list to point to the second-doubly linked list (and vice-versa). In this manner, when the memory manager 119 is seeking out a group of free sectors 108 having a size of seven (7), the memory manager 119 can reference the search array 806 at index seven (7) to identify and remove the first doubly-linked list from the chain. To appropriately reflect this change, the memory manager 119 would then update the pointer within the search array 806 at index seven (7) to point to the second doubly-linked list, and update the second doubly-linked list to point back to the search array 806 at index seven (7).

FIG. 8 illustrates a conceptual diagram of an example scenario that involves an example search array 806 and example doubly-linked lists 808 that are organized in accordance with the example search array 806, according to one embodiment. As shown in FIG. 8B, the search array 806 includes two hundred fifty-seven (257) entries (e.g., in accordance with a fixed size of two hundred fifty-six (256) of the first tier span 122), where each entry of the search array 806 points to doubly-linked lists that define groups of free sectors 108 whose sizes correspond to the index of the entry. For example, entry five (5) of the search array 806 would point to doubly-linked lists that define groups of five (5) free sectors 108, entry four (4) of the search array 806 would point to doubly-linked lists that define groups of four (4) free sectors 108, and so on. According to the illustration of FIG. 8B, entry zero (0) of the search array 806 can be reserved to point to doubly-linked lists that define groups of free sectors 108 whose sizes exceed the upper bound limit (e.g., two hundred fifty-six (256)) of the search array 806. According to one embodiment, the memory manager 119 can be configured to disregard smaller groups of sectors 108 (e.g., four sectors 108 or fewer) and not include such groups in the doubly-linked lists, which is also reflect in FIG. 8B (as indexes 3-1 are ignored). Instead, these smaller groups can be utilized as changes to the organization of the memory 106 occur, e.g., through reclamation during cleaning up procedures (e.g., defragmentation operations), de-allocation of adjacent sectors 108, and the like.

Additionally, and although not illustrated in FIGS. 8A-8B, the memory manager 119 can be configured to implement an allocation node that can be used to organize a large group of free sectors 108 from which variably-sized groups of sectors 108 can be allocated. Specifically, the allocation node can be used when the memory manager 119 is seeking a group free sectors 108 of a particular size (e.g., using the bucket approach described above) and the particular size is not available. When this occurs, the memory manager 119 can de-allocate a group of free sectors 108 from the allocation node in accordance with the desired size. This is beneficial in comparison to, for example, defaulting to seeking out a next-available group of free sectors 108 within the search array 806, which would increase fragmentation and decrease overall efficiency.

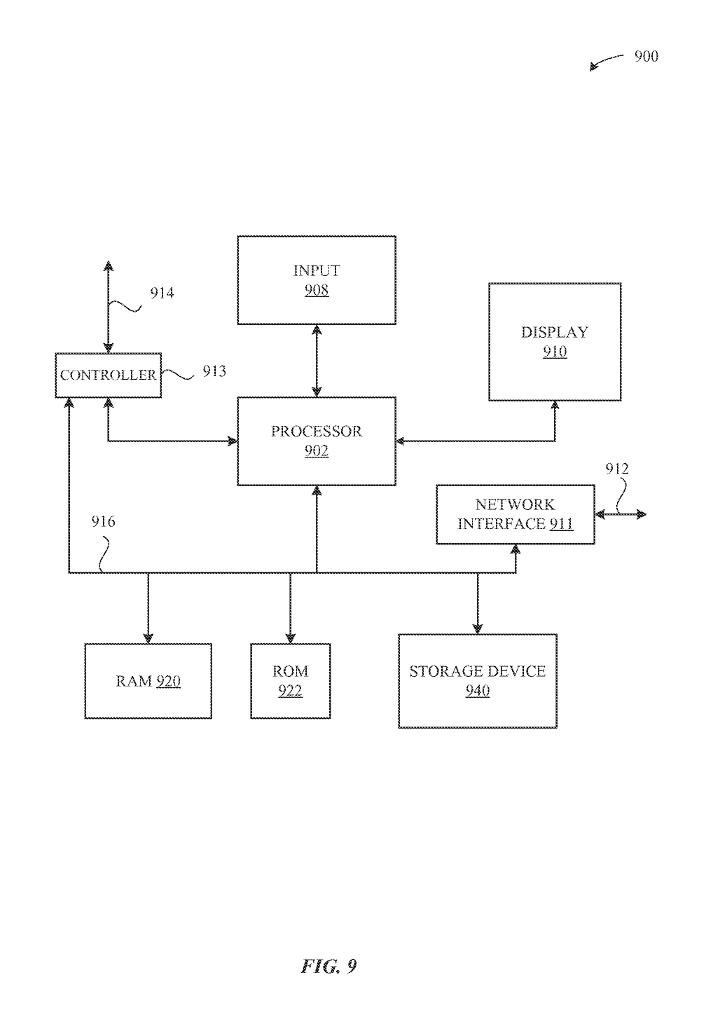

FIG. 9 illustrates a detailed view of a computing device 900 that can be used to implement the various components described herein, according to some embodiments. In particular, the detailed view illustrates various components that can be included in the computing device 102 illustrated in FIG. 1. As shown in FIG. 9, the computing device 900 can include a processor 902 that represents a microprocessor or controller for controlling the overall operation of computing device 900. The computing device 900 can also include a user input device 908 that allows a user of the computing device 900 to interact with the computing device 900. For example, the user input device 908 can take a variety of forms, such as a button, keypad, dial, touch screen, audio input interface, visual/image capture input interface, input in the form of sensor data, etc. Still further, the computing device 900 can include a display 910 (screen display) that can be controlled by the processor 902 to display information to the user. A data bus 916 can facilitate data transfer between at least a storage device 940, the processor 902, and a controller 913. The controller 913 can be used to interface with and control different equipment through and equipment control bus 914. The computing device 900 can also include a network/bus interface 911 that couples to a data link 912. In the case of a wireless connection, the network/bus interface 911 can include a wireless transceiver.

The computing device 900 also includes a storage device 940, which can comprise a single disk or a plurality of disks (e.g., SSDs), and includes a storage management module that manages one or more partitions within the storage device 940. In some embodiments, storage device 940 can include flash memory, semiconductor (solid state) memory or the like. The computing device 900 can also include a Random Access Memory (RAM) 920 and a Read-Only Memory (ROM) 922. The ROM 922 can store programs, utilities or processes to be executed in a non-volatile manner. The RAM 920 can provide volatile data storage, and stores instructions related to the operation of the computing device 102.

The various aspects, embodiments, implementations or features of the described embodiments can be used separately or in any combination. Various aspects of the described embodiments can be implemented by software, hardware or a combination of hardware and software. The described embodiments can also be embodied as computer readable code on a computer readable medium. The computer readable medium is any data storage device that can store data which can thereafter be read by a computer system. Examples of the computer readable medium include read-only memory, random-access memory, CD-ROMs, DVDs, magnetic tape, hard disk drives, solid state drives, and optical data storage devices. The computer readable medium can also be distributed over network-coupled computer systems so that the computer readable code is stored and executed in a distributed fashion.

What is claimed is:

1. A method for implementing memory management for a storage device, the method comprising:
managing a hierarchical structure that includes, at most, a first tier and a second tier,
wherein:
the first tier is associated with a plurality of first tier entries, and each first tier entry of the plurality of first tier entries defines:
(i) an address of a sector of the storage device, or
(ii) a pointer to a second tier entry associated with the second tier, and a format that identifies how data is stored in the second tier entry and any other second tier entries that follow the second tier entry.

2. The method of claim 1, wherein, for each first tier entry of the plurality of first tier entries, a subset of bits that comprise the first tier entry indicate whether the first tier entry defines (1), or defines (ii).

3. The method of claim 2, wherein, when a first tier entry of the plurality of first tier entries indicates that the first tier entry defines (i):
data is stored beginning at the sector of the storage device, and the data contiguously spans across a fixed number of sectors that follow the sector of the storage device,

4. The method of claim 2, wherein, when a first tier entry of the plurality of first tier entries indicates that the first tier entry defines (ii):
at least one of the second tier entry and the other second tier entries references a different sector of the storage device.

5. The method of claim 2, wherein, when a first tier entry of the plurality of first tier entries indicates that the first tier entry defines (ii):
at least one of the second tier entry and the other second tier entries references:
an address of a specific sector of the storage device, and
a size value that indicates a number of sectors that follow the specific sector.

6. The method of claim 5, wherein, when a first tier entry of the plurality of first tier entries indicates that the first tier entry defines (ii):
a particular second tier entry among the other second tier entries functions to extend the size value.

7. The method of claim 1, further comprising, when a first tier entry of the plurality of first tier entries indicates that the first tier entry defines (ii):
generating, based on the second tier entry and a last second tier entry of the other second tier entries, a doubly-linked list, wherein the doubly-linked list identifies a number of free sectors of the storage device within the first tier entry.

8. The method of claim 7, further comprising:
producing an updated doubly-linked list by chaining the doubly-linked list to other doubly-linked lists, if any, that share the same number of free sectors.

9. The method of claim 8, further comprising:
establishing a search array having a plurality of entries, wherein:
at least one entry of the plurality of entries points to the updated doubly-linked list, and
an index associated with the at least one entry corresponds to the number of free sectors.

10. A non-transitory computer readable storage medium configured to store instructions that, when executed by a processor included in a computing device, cause the computing device to implement memory management for a storage device, by carrying out steps that include:
managing a hierarchical structure that includes, at most, a first tier and a second tier,
wherein:
the first tier is associated with a plurality of first tier entries, and each first tier entry of the plurality of first tier entries defines:
(i) an address of a sector of the storage device, or
(ii) a pointer to a second tier entry associated with the second tier, and a format that identifies how data is stored in the second tier entry and any other second tier entries that follow the second tier entry.

11. The non-transitory computer readable storage medium of claim 10, wherein, for each first tier entry of the plurality of first tier entries, a subset of bits that comprise the first tier entry indicate whether the first tier entry defines (i), or defines (ii).

12. The non-transitory computer readable storage medium of claim 11, wherein, when a first tier entry of the plurality of first tier entries indicates that the first tier entry defines (i):
data is stored beginning at the sector of the storage device, and the data contiguously spans across a fixed number of sectors that follow the sector of the storage device.

13. The non-transitory computer readable storage medium of claim 11, wherein, when a first tier entry of the plurality of first tier entries indicates that the first tier entry defines (ii):
at least one of the second tier entry and the other second tier entries references a different sector of the storage device.

14. The non-transitory computer readable storage medium of claim 11, wherein, when a first tier entry of the plurality of first tier entries indicates that the first tier entry defines (ii):
at least one of the second tier entry and the other second tier entries references:
an address of a specific sector of the storage device, and
a size value that indicates a number of sectors that follow the specific sector.

15. The non-transitory computer readable storage medium of claim 14, wherein, when a first tier entry of the plurality of first tier entries indicates that the first tier entry defines (ii):
a particular second tier entry among the other second tier entries functions to extend the size value.

16. The non-transitory computer readable storage medium of claim 10, wherein the steps further include, when it first tier entry of the plurality of first tier entries indicates that the first tier entry defines (ii):
generating, based on the second tier entry and a last second tier entry of the other second tier entries, a doubly-linked list, wherein the doubly-linked list identifies a number of free sectors of the storage device within the first tier entry.

17. The non-transitory computer readable storage medium of claim 16, further comprising:
producing an updated doubly-linked list by chaining the doubly-linked list to other doubly-linked lists, if any, that share the same number of free sectors.

18. The non-transitory computer readable storage medium of claim 17, further comprising:
establishing a search array having a plurality of entries, wherein:
at least one entry of the plurality of entries points to the updated doubly-linked list, and
an index associated with the at least one entry corresponds to the number of free sectors.

19. A computing device configured to implement memory management for a storage device, the computing device comprising:
a storage device; and
a processor configured to carry out steps that include:
managing a hierarchical structure that includes, at most, a first tier and a second tier, wherein:
the first tier is associated with a plurality of first tier entries, and each first tier entry of the plurality of first tier entries defines:
(i) an address of a sector of the storage device, or
(ii) a pointer to a second tier entry associated with the second tier, and a format that identifies how data is stored in the second tier entry and any other second tier entries that follow the second tier entry.

20. The computing device of claim 19, wherein, when a first tier entry of the plurality of first tier entries indicates that the first tier entry defines (ii):
at least one of the second tier entry and the other second tier entries references:
an address of a specific sector of the storage device, and
a size value that indicates a number of sectors that follow the specific sector.
